(19) United States
(12) Patent Application Publication
(10) Pub. No.: US 2006/0051603 A1
(43) Pub. Date: Mar. 9, 2006

(54) Biodegradable paper-based cup or package and production method

(75) Inventors: Christopher Scott Cleveland, Newport, KY (US); Tricia Susan Reighard, Loveland, OH (US)

Correspondence Address: LERNER AND GREENBERG, PA, P O BOX 2480, HOLLYWOOD, FL, 33022-2480, US

(73) Assignee: International Paper Company

(21) Appl. No.: 11/221,175

(22) Filed: Sep. 7, 2005

Related U.S. Application Data
(60) Provisional application No. 60/608,258, filed on Sep. 9, 2004.

(51) Int. Cl. B32B 27/10; B32B 7/12; G03G 5/10; B32B 7/02

(52) U.S. Cl. 428/481; 428/212; 428/342; 428/349; 428/34.2; 427/372.2

(57) ABSTRACT

There is disclosed a biodegradable laminate suitable for use in shaped paper-based articles such as containers for liquid or solid, hot or cool, food products, comprising a paper-based substrate having first and second copolyester layers deposited onto at least one surface of the substrate, in the substantial absence of intervening polymer layers between the substrate surface and the copolyesters deposited on the substrate surface. A biodegradable shaped article formed from the laminate and a method for forming a biodegradable laminate are also disclosed.

### CROSS-REFERENCE TO RELATED APPLICATION

This application claims the benefit, under 35 U.S.C. § 119(e), of copending provisional patent application No. 60/608,258, filed Sep. 9, 2004.

### BACKGROUND OF THE INVENTION

### Field of the Invention

This invention relates to biodegradable paper-based laminates.

Paper cups for disposable food service uses are typically extrusion coated with low density polyethylene (LDPE) or other similar polymer(s) in order to hold liquids for a longer period of time without leaking or becoming soft as is common with 100% paper cups. Cups for hot beverages such as coffee have a layer of LDPE on the inside for liquid resistance. Cold drink cups for soft drinks and the like are typically coated with LDPE on both sides to prevent condensation that forms on the outside of the cup from softening the paper. LDPE coat weights of 0.5-1.5 mils (7.2-21.6 lb/3000 ft²) are common.

These types of cups are used once or a very minimal number of times then disposed. While the paper substrate is typically degradable, the LDPE coating is not readily degradable (and compostable), and therefore, the cup may remain in a landfill for many years without breaking down. The use of one or more biodegradable polymers in lieu of LDPE is desirable to render the used cups more “environmentally friendly”.

In addition to cups, other coated paper products such as gable top cartons, folding cartons, paper pouches, sandwich wraps, paper plates and bowls, and ream wrap can also benefit from the present invention.

### SUMMARY OF THE INVENTION

It is accordingly an object of the invention to provide a biodegradable laminate suitable for coating shaped paper-based articles such as containers that overcomes the disadvantages of the prior art materials and methods of this general type, that is biodegradable in a compost environment.

It is a further object of the invention to provide a method for forming a biodegradable laminate suitable for coating shaped paper-based articles.

It is also a further object of the invention to provide a shaped paper-based article comprising a biodegradable laminate.

With the foregoing and other objects in view, there is provided, in accordance with this invention, a biodegradable laminate suitable for use in shaped paper-based articles such as containers for liquid or solid, hot or cool, food products. The biodegradable laminate comprises a paper-based substrate having two or more surfaces, and deposited onto at least one surface of the substrate at least one layer of a first copolyester and at least one layer of a second copolyester in the substantial absence of intervening polymer layers between the substrate surface and the first copolyester layer disposed on the substrate surface. A first copolyester layer is an inner layer providing adhesion to the paper-based substrate, and a second copolyester layer is an outer layer preventing chill roll sticking and blocking in the roll and providing greater thermal stability compared to said first layer. The first copolyester and the second copolyester are not identical.

The copolyester materials of the present invention are products of copolymerization of benzene-1,4-dicarboxylic acid with an aliphatic dihydric alcohol and at least one reactant selected from the group consisting of an aliphatic dicarboxylic acid and a cyclic dihydric alcohol. Suitable dihydric alcohols include 1,4-butanediol, 2,2-dimethyl-1,3-propanediol, and ethylene glycol. Suitable aliphatic dicarboxylic acids include 1.6-hexanedioic acid, 1,8-nonanedioic acid, 1,10-decanedioic acid, and 1,12-dodecanedioic acid. Suitable cyclic dihydric alcohols include cyclohexane-1,4-dimethanol, 1,1,3,3-tetraqmethylcyclobutane-2,4-diol, and 1,4:3,6-dianhydro-D-sorbitol

A particularly preferred first copolyester is a product of copolymerization of benzene-1,4-dicarboxylic acid with adipic acid and 1,4-butanediol. This product is commercially available under the trade names ECOFLEX and EASTAR BIO.

A particularly preferred second copolyester is a product of copolymerization of benzene-1,4-dicarboxylic acid with ethylene glycol and 1,4:3,6-dianhydro-D-sorbitol. This product is commercially available under the trade name BIOMAX.

A particularly preferred manner of depositing the layers of copolyester is by coextrusion, suitably onto a moving web of paper or paperboard.

The copolyester materials of the present laminate have been certified to be biodegradable in a compost environment (as tested per ASTM D6400-99) thereby rendering the laminate highly desirable as a material for use in forming food containers which are commonly used once, or a minimum number of times, before disposal thereof. Likewise, the biodegradability of the present laminate renders the laminate useful in other “one-use” paper-based products such as sandwich wrap, ream wrap, etc.

In one embodiment, the present laminate may be provided with a coextruded layer of the same or other copolyesters on the opposite surface of the paper-based substrate.

There is also provided, in accordance with this invention, a biodegradable shaped paper-based article, such as a biodegradable container or a blank or semi-finished intermediate capable of being shaped into a container, formed from the biodegradable laminate.

There is, furthermore, provided, in accordance with this invention, a method for forming a biodegradable laminate suitable for use in shaped paper-based articles.

Other features which are considered as characteristic for the invention are set forth in the appended claims.

Although the invention is illustrated and described herein as embodied in a biodegradable paper-based cup or package, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIGS. 1 and 2 are schematic perspective views representing an embodiment of a laminate embodying various features of the present invention;

FIG. 3 is a schematic representation of a second embodiment of a laminate embodying various features of the present invention; and

FIG. 4 is a diagrammatic representation of a process for the formation of a laminate of the present invention.

### DESCRIPTION OF THE PREFERRED EMBODIMENTS

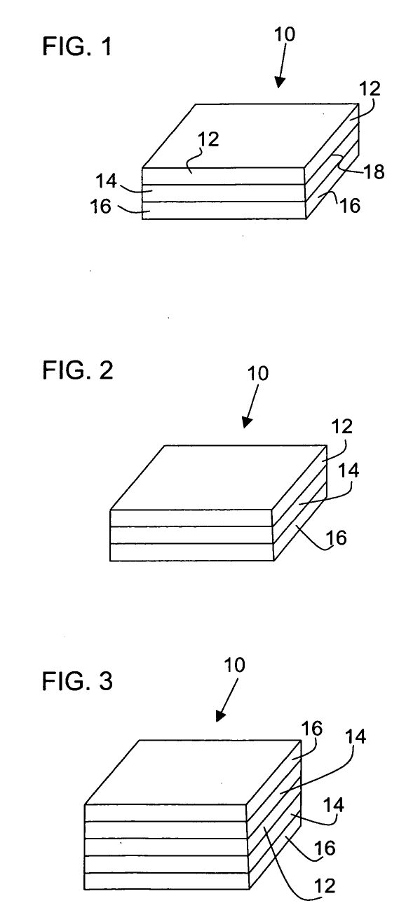

Referring now to the figures of the drawing in detail and first, particularly, to FIGS. 1 to 3 thereof, there is shown a biodegradable laminate 10 which is paper-based, meaning that the substrate 12 of the laminate comprises paper, commonly a paper-based stock known as SBS cupstock or SUS (natural) kraft folding carton board, all of which are well known in the art.

The laminate of the present invention further includes first and second layers 14 and 16, respectively, of copolyesters which are coextruded onto one 18 of the surfaces of the paper-based substrate.

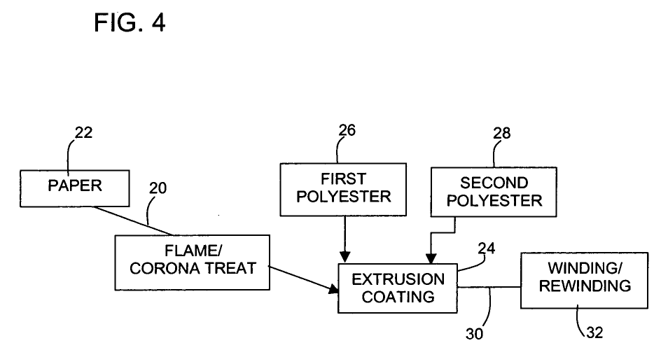

As depicted in FIG. 4, formation of the laminate of the present invention includes feeding a continuous sheet 20 of SBS or other acceptable paper-based substrate from a roll 22 thereof, forwardly into a conventional coextruder 24 which is fed a first copolyester 26 and a second copolyester 28. The first and second copolyesters are coextruded onto the flat surface 18 of the paper-based substrate and thereafter collected, as by winding the completed laminate 30 onto a spindle 32, or the like. Thereafter, the laminate may be formed into a cup, pouch, gable top container, or other container for a food product, suitably by first making a blank or intermediate, and converting that into the finished article. The container thus formed is useful for containing either liquid, solid or semi-solid food product, irrespective of whether the food product is cold or hot (within the normal temperature bounds of heated and cooled food products). An example of a hot food product is hot coffee at about 180° F. An example of a cool food product is iced tea at 33-40° F.

In a preferred embodiment, the paper-based substrate of the laminate of the present invention comprises either SBS (solid bleached sulfate) cupstock or SUS (solid unbleached sulfate) (natural kraft) folding carton board. The preferred range of board thickness ranges between about 100-300 lb/3000 ft². Other examples of acceptable basestock (substrate) include, liquid packaging board, SBS folding carton board, natural Kraft cupstock, light weight Kraft or SBS papers, and board or paper with post-consumer waste (“recycled”) content. The light weight papers are defined as less than 100 lb/3000 ft² The liquid packaging board may be used for gable top cartons for products such as dairy, for example. Uses of the light weight papers include pouches for powders or other dry products like oatmeal, sandwich wraps for quick serve restaurants, and ream wrap for copy paper.

In accordance with one aspect of the present invention as depicted in FIGS. 1 and 2, there is applied to at least one flat surface of the paper-based substrate a coextruded combination of a copolyester, namely, either a copolyester produced from the copolymerization of 1,4-benzenedicarboxylic acid (terephthalic acid), 1,4-butanediol, and adipic acid as well as a chain extender or branching agent (available from BASF under the name ECOFLEX® having a melting point (MP) range of 212-248° F.), or a copolyester produced from the copolymerization of 1,4 benzene dicarboxylic acid (terephthalic acid), 1,4-butanediol and adipic acid (the resulting copolyester being poly(tetramethylene adipate-co-terephthalate)(available from Eastman Chemical/Novamont under the name Eastar Bio® having a MP of 226° F.), and a copolyester produced by the condensation reaction of 1,4-benzenecarboxylic acid, ethylene glycol, and 1,4:3,6-dianhydro-D-sorbitol (available from DuPont under the name Biomax® having a MP of 383° F.)

As depicted in FIG. 1, in a preferred embodiment for use with containers for hot food products, a paper-based substrate is provided on one flat surface thereof with a coextruded layer of Ecoflex and Biomax. Individually in a compost environment, about 90% of Ecoflex resin biodegrades within about 80 days and about 95% of Biomax resin biodegrades within about 63 days. In a study conducted by a university lab, greater than 90% of the coated laminate biodegrades in about 88 days, meeting the criteria for biodegradability/compostability according to ASTM standards D6400-99 and D6868.

In this preferred embodiment for hot food containers, a total coextrusion coat weight of between about 10 and about 40, lb/3000 ft², in any combination of between about 80/20 to 20/80 parts by weight of Ecoflex to Biomax may be employed. A total coat weight of about 25 lb/3000 ft² is preferred, for both processability and end use performance. Preferably, the Biomax is applied at between about 5 and about 20 lb/3000 ft², the remainder of the total coat weight being Ecoflex. For a hot beverage cup, for example, the coextrusion is applied to the coated side of the paper-based substrate. Flame and/or corona pre-treatment of the substrate surface may be employed to enhance adhesion, as desired or needed. Lighter total coat weights may be employed, but at the possible loss of heat seal quality in subsequent finished packages (cups, gable top containers, etc.). Heavier total coat weights may also be used but material costs may outweigh any incremental performance advantages of such heavier total coat weights, and/or may slow down the overall degradation rate of the container.

Further, it has been found that use of Ecoflex as a monolayer in a laminate for biodegradation purposes typically requires slip/antiblock additive packages to prevent chill roll sticking and blocking in the roll of finished laminate. Further, considerable neck-in is experienced with one or more of the copolyesters when it is applied as a monolayer, resulting in excessive trim and waste. Biomax, in particular, when applied as a monolayer does not satisfactorily adhere to the paper-based substrate. In contrast, employing a combination in accordance with this invention of the noted copolyesters has been found effective in overcoming the shortcomings of the copolyesters when applied as a monolayer.

Containers for cool food products preferably are formed from a laminate as depicted in FIG. 3. This depicted laminate includes a paper-based substrate having a first layer of coextruded Eastar Bio or Ecoflex (preferably Ecoflex) and Biomax provided on one flat surface of the substrate, the Biomax being disposed outermost from the substrate. Further a second layer of coextruded Eastar Bio or Ecoflex (preferably Ecoflex) and Biomax is provided on the opposite flat surface of the substrate, the Biomax again being disposed outermost from the substrate. In this embodiment for cool food containers, the coextruded layer of copolyester (irrespective of which side of the substrate the layer is disposed) is of a total coat weight of between about 10 and about 40 lb/3000 ft² in any combination of between about 80/20 to 20/80 parts by weight of Ecoflex to Biomax. A total coat weight of about 25 lb/3000 ft² is preferred. As in a laminate intended for use with hot food product, in this laminate intended for use with a cool food product, the Biomax is applied at a coat weight of between about 5 and 20 lb/3000 ft², the remainder of the total coat weight being either Ecoflex or Eastar Bio.

In a further embodiment, as depicted in FIG. 1, the paper-based substrate 12 can be provided with a coextruded layer of Eastar Bio 14 and Biomax 16 on one of the flat surfaces of the substrate. In this embodiment, a total coat weight of between about 10 and about 40, lb/3000 ft², in any combination of between about 80/20 to 20/80 parts by weight of Eastar Bio to Biomax may be employed. A total coat weight of about 25 lb/3000 ft² is preferred. The Biomax is applied at a coat weight of between about 5 and 20 lb/3000 ft², the remainder of the total coat weight being Eastar Bio.

As desired, calcium carbonate may be added to any or all of the copolyester extrusions as a cost savings measure and to provide increase in the degradation rate by displacement of some of the biodegradable resin material. Other possible organic and inorganic fillers may be employed with, or in lieu of, calcium carbonate, including starch, clay, kaolin, talc, cellulose fibers, and diatomaceous earth.

A two-layer coextrusion coating consisting of BASF Ecoflex and DuPont Biomax was applied to SBS cupstock and natural Kraft folding carton paperboards. Basis weights of the SBS and kraft were in the range of 180-210 lb/3000 ft2. Melt processing temperatures of the two resins were 450° F. and 465° F., respectively.

Coat weights applied were 12.5 lb/3000 ft² Ecoflex and 12.5 lb/3000 ft² Biomax. Total coat weights of at least 10 lb/3000 ft² to 25 lb/3000 ft² provided good melt strength and minimal edge weave of the coextrusion curtain.

The blanks and intermediate materials having biodegradable laminate coextruded on SBS cupstock and SUS folding carton board produced as set forth above, were converted into cups on a PMC 1000 cup forming machine at a rate of 140 cups per minute. All cups passed testing for holding coffee (at 180° F.) for at least 25 minutes without leakage, softening of the coating, or visual contamination of the beverage by the coating.

Heat seal testing was conducted on standard low density polyethylene (LDPE) coated cupstock and the coated Kraft folding carton materials onto which the Ecoflex and Biomax were coextruded. For each substrate, samples were placed coated side to uncoated side in a Barber-Coleman sealing unit. Sealing pressure was held constant at 80 psi and dwell time was held at 5 seconds. Temperatures were varied to determine the minimum temperature at which 100% fiber tear was obtained. Following the sealing step, the samples were allowed to cool for 30 second before manually pulling the layers apart and visually evaluating the extent of fiber tear. For the standard LDPE coated cupstock, the minimum sealing temperature was 215° F. The Kraft board coated with Ecoflex and Biomax sealed at a slightly lower minimum temperature of 210° F.

In accordance with one aspect of the present invention, it is noted that the coextrusion of two copolyesters provides multiple benefits. For example, Eastar Bio and Ecoflex adhere well to paper, resulting in 100% fiber tear. On the other hand, the level of adhesion between Biomax and the paper is far less, resulting in very little fiber tear. Thus, in the present invention, an Eastar Bio or Ecoflex layer of the coextrusion is disposed directly adjacent to the paperboard substrate to gain good adhesion. Biomax is less sticky than either the Eastar Bio or Ecoflex. Therefore, a Biomax layer of the coextrusion is disposed outermost of the layers of the laminate to prevent sticking of the laminate to the chill roll and to preclude blocking of the laminate in the roll.

Further, Biomax has a significantly higher melting point than either Eastar Bio or Ecoflex (Tₘ=383° F. for Biomax vs. 226° F. for Eastar Bio and 212-248° F. for Ecoflex), so that the positioning of the Biomax as the outermost layer of the laminate in contact with the hot food product allows a container formed from the laminate to better withstand deterioration and softening of the coating by the hot food product.

We claim:

1. A biodegradable laminate, comprising a paper-based substrate having laminated thereto at least one layer of a first copolyester and at least one layer of a second copolyester, said layers being deposited onto at least one surface of said substrate, wherein a first layer is an inner layer providing adhesion to the paper-based substrate, and a second layer is an outer layer preventing chill roll sticking and blocking in the roll and providing greater thermal stability compared to said first layer.

2. The biodegradable laminate of claim 1, wherein the copolyesters of said first and second layers are non-identical copolymerization products of benzene-1,4-dicarboxylic acid with an aliphatic dihydric alcohol and at least one reactant selected from the group consisting of an aliphatic dicarboxylic acid and a cyclic dihydric alcohol.

3. The biodegradable laminate of claim 2, wherein said dihydric alcohol is 1,4-butanediol and said at least one reactant is 1,6-hexanedioic acid.

4. The biodegradable laminate of claim 2, wherein said dihydric alcohol is ethylene glycol and said at least one reactant is 1,4:3,6-dianhydro-D-sorbitol.

5. The biodegradable laminate of claim 1, wherein the copolyesters of said first and second layers are non-identical copolymerization products of benzene-1,4-dicarboxylic acid with an aliphatic dihydroxy alcohol and at least one reactant selected from the group consisting of an aliphatic dicarboxylic acid and an aromatic dihydroxy alcohol.

6. The biodegradable laminate of claim 1, wherein said copolyester layers have differing melting points, and the lower melting copolyester is disposed between said substrate and the higher melting copolyester.

7. The biodegradable laminate of claim 1, wherein the proportions of first copolyester and second copolyester range from 20 parts by weight of said first copolyester to 80 parts by weight of said second copolyester to 80 parts by weight of said first copolyester to 20 parts by weight of said second copolyester.

8. The biodegradable laminate of claim 1, wherein the total coat weight of said first and second copolyesters is in a range from about 10 to about 40 lb/3000 ft².

9. The biodegradable laminate of claim 8, wherein the total coat weight of first and second copolyesters is 25 lb/3000 ft².

10. The biodegradable laminate of claim 1, wherein an inorganic filler is added to at least one copolyester layer.

11. The biodegradable laminate of claim 10, wherein the inorganic filler is calcium carbonate.

12. The biodegradable laminate of claim 1, wherein the copolyester layers can be heat sealed.

13. The biodegradable laminate of claim 1, configured to biodegrade in accordance with criteria for biodegradability/compostability as specified in ASTM standards D6400-99 and D6868.

14. A biodegradable paper-based shaped article comprising a paper-based substrate having at least two surfaces and a biodegradable laminate provided on at least one surface of said substrate, wherein said laminate has an inner layer of first copolyester laminated thereto, said first copolyester layer providing adhesion to the paper-based substrate, and an outer layer of second copolyester preventing chill roll sticking and blocking in the roll and providing greater thermal stability compared to said first layer, and wherein the copolyesters of said first and second layers are non-identical copolymerization products of benzene-1,4-dicarboxylic acid with an aliphatic dihydric alcohol and at least one reactant selected from the group consisting of an aliphatic dicarboxylic acid and a cyclic dihydric alcohol.

15. The biodegradable shaped article of claim 14, wherein said paper-based substrate has a layer of said first and second copolyesters provided on one surface of said substrate, and a second layer of said first and second copolyesters is provided on the opposite surface of said substrate.

16. The biodegradable shaped article of claim 14, wherein said paper-based substrate has a layer of said first and second copolyesters provided on one surface of said substrate, and the opposite surface of said substrate is uncoated.

17. The biodegradable shaped article of claim 14 having a shape selected from the group consisting of cups, gable top cartons, folding cartons, paper pouches, sandwich wraps, paper plates and bowls, ream wrap and blanks for the manufacture thereof.

18. The biodegradable shaped article of claim 14 being a blank for use in producing a cup for cold food products.

19. The biodegradable shaped article of claim 14 being a cup for cold food products.

20. A pouch, gable top carton, or other container for liquid, solid, or semi-solid food and non-food products constructed from a laminate according to claim 15.

21. A packaging wrap constructed from a laminate according to claim 15.

22. A method of forming a biodegradable paper-based shaped article, which comprises the following steps:
a) providing a paper-based substrate having a basis weight in the range of 100-300 lb/3000 ft2 and at least one flat surface;
b) applying to at least one flat surface of the substrate a laminate of at least one first copolyester and at least one second copolyester, the first copolyester and the second copolyester being non-identical; and
c) shaping the article;
wherein a layer of first copolyester is an inner layer providing adhesion to the paper-based substrate, and a layer of second copolyester is an outer layer preventing chill roll sticking and blocking in the roll and providing greater thermal stability compared to the inner layer, and wherein the first and second copolyesters are non-identical copolymerization products of benzene-1,4-dicarboxylic acid with an aliphatic dihydric alcohol and at least one reactant selected from the group consisting of an aliphatic dicarboxylic acid and a cyclic dihydric alcohol.

23. The method of claim 22, wherein the first and second copolyesters are non-identical copolymerization products of benzene-1,4-dicarboxylic acid with an aliphatic dihydroxy alcohol and an aliphatic dicarboxylic acid or an aromatic dihydroxy alcohol forming a reactant.

24. The method of claim 22, wherein the total coat weight of copolyesters is in the range from about 10 to about 40 lb/3000 ft².

25. The method of claim 22, wherein the first and second copolyesters have differing melting points, and the lower melting copolyester is disposed between the substrate and the higher melting copolyester.

26. The method of claim 22, wherein a layer of copolyesters is applied to one surface of the substrate, and a second layer of copolyesters is applied to the opposite surface of the substrate.

27. The method of claim 22, wherein a layer of copolyesters is applied to one surface of the substrate, and the opposite surface of said substrate is uncoated.

28. The method of claim 22, wherein the at least two copolyesters are applied to the substrate by coextrusion together onto a moving web of paper or paperboard.

29. The method of claim 28 wherein the extrusion melt temperatures for the first and second copolyester layers are in the range of 440-510° F.
